(19) United States
(12) Patent Application Publication
(10) Pub. No.: US 2006/0268699 A1
(43) Pub. Date: Nov. 30, 2006

(54) High speed serial bus architecture employing network layer quality of service (QoS) management

(75) Inventors: Sergey Balandin, Helsinki (FI); Michel Gillet, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/140,424

(22) Filed: May 27, 2005

(51) Int. Cl. H04L 12/26

(52) U.S. Cl. 370/230

(57) ABSTRACT

In accordance with the non-limiting and exemplary embodiments of this invention a functional unit includes a protocol stack that includes a physical layer for coupling to a communication link, a datalink layer coupled to the physical layer, and a network layer coupled to the datalink layer. The datalink layer includes a common data queue for storing traffic passing through the communication link and the network layer includes a first queue for storing data associated with first traffic having a requested quality of service QoS and a logically separate second queue for storing data associated with second traffic not having a requested quality of service.

### TECHNICAL FIELD

The teachings in accordance with the exemplary embodiments of this invention relate generally to communication buses and architectures and, more specifically but not exclusively, relate to serial bus systems and architectures.

### BACKGROUND

An important element of many electronic systems is the communications bus that interconnects various functional modules within the system. The functional modules may be discrete modules, or they may be integrated into a common integrated circuit (IC) or chip, such as in a System-on-a-Chip (SoC) type of architecture. The communications bus in this latter case may also be routed off-chip for connecting to external functional modules and/or to another electronic system, such as an accessory device or a peripheral device.

One very advantageous type of communications bus architecture is implemented as a high speed serial bus, and is described in, for example, the following commonly assigned U.S. patent application: Ser. No. 10/684,169, Oct. 10, 2003, “Method and Apparatus Employing Pam-5 Coding with Clock Embedded in Data Stream and Having a Transition When Data Bits Remain Unchanged”, Martti Voutilainen (U.S. Pat. No. 2005-0078712-A1); Ser. No. 10/961,366, Oct. 7, 2004, “Communications Bus Having Low Latency Interrupts and Control Signals, Hotpluggability Error Detection and Recovery, Bandwidth Allocation, Network Integrity Verification, Protocol Tunneling and Discoverability Features”, Michel Gillet; and Ser. No. 10/961,661, Oct. 8, 2004, “Microcontrol Architecture for a System on a Chip (SoC)”, Kim Sandstrom. The disclosures of these commonly-assigned U.S. patent applications are incorporated herein by reference in their entireties.

The low power, high speed serial link bus that is an element of the foregoing commonly assigned U.S. patent applications is well suited for use in portable terminals, such as communications terminals, but also has broader applicability. Advantages realized by the use of this high speed serial link bus include, but are not limited to: only a few signal lines are needed, thereby reducing the number of pins or balls on the IC package and thereby reducing cost; improved EMC immunity; an ability to replace existing buses because of inherent modularity and generality; and an ability to provide hotpluggable units that connect to the bus.

### SUMMARY OF THE EXEMPLARY EMBODIMENTS

In accordance with the non-limiting and exemplary embodiments of this invention, in a first aspect thereof a functional unit includes a protocol stack comprised of a physical layer for coupling to a communication link, a datalink layer coupled to the physical layer, and a network layer coupled to the datalink layer. The datalink layer comprises a common data queue for storing all traffic passing through the communication link and the network layer comprises a first queue for storing data associated with first traffic having a requested quality of service QoS and a logically separate second queue for storing data associated with second traffic not having a requested quality of service.

In a second aspect the non-limiting embodiments of the invention provide a method to communicate data over a communication link. The method includes providing a protocol stack comprised of a physical layer for coupling to the communication link, a datalink layer coupled to the physical layer, and a network layer coupled to the datalink layer; in the datalink layer, operating a common data queue for storing all traffic passing through the communication link; and in the network layer, operating a first queue for storing data associated with first traffic having a requested quality of service QoS and operating a logically separate second queue for storing data associated with second traffic comprised of best effort traffic.

In a further aspect thereof the non-limiting embodiments of the invention provide a computer program product embodied on a computer readable medium for directing at least one data processor to communicate data over a communication link by operations that include providing a protocol stack comprised of a physical layer for coupling to the communication link, a datalink layer coupled to the physical layer, and a network layer coupled to the datalink layer; in the datalink layer, operating a common data queue for storing all traffic passing through the communication link; and in the network layer, operating a first queue for storing data associated with first traffic having a requested quality of service QoS and operating a logically separate second queue for storing data associated with second traffic comprised of best effort traffic.

In a still further aspect thereof the non-limiting embodiments of the invention provide a terminal that includes at least a first functional unit and a second functional unit that are communicatively coupled together through a link. Each of the functional units comprises a protocol stack comprised of a physical layer for coupling to the link, a datalink layer coupled to the physical layer, and a network layer coupled to the datalink layer. The datalink layer comprises a common data queue for storing traffic passing through said link and said network layer comprising a first queue for storing data associated with first traffic having a requested quality of service QoS and a logically separate second queue for storing data associated with second traffic not having a requested quality of service.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a block diagram of a terminal that includes two exemplary functional units that are constructed and operated in accordance with the non-limiting embodiments of this invention;

FIG. 2 shows the format of a QoS request packet that is an aspect of this invention;

FIG. 3 shows the format of a QoS flow packet that is a further aspect of this invention;

FIG. 4 shows an example of a resource allocation time circle; and

FIG. 5 is a logic flow diagram than shows the operation of the Datalink layer common Queue Access Logic (QAL) shown in FIG. 1.

### DETAILED DESCRIPTION

The non-limiting and exemplary embodiments of this invention provide enhanced QoS functionality for a communications bus, and may be used to advantage in the high speed serial bus that was discussed above and that is described in the U.S. patent application Ser. Nos. 10/684,169, 10/961,366 and 10/961,661. It should be appreciated, however, that the enhanced QoS functionality in accordance with the teachings of this invention may be applied to and used with other types of bus systems, both serial and non-serial. The teachings of this invention provide a traffic treatment technique that employs two priority levels, where all or substantially all the corresponding buffering and management complexity is pushed up to the Network layer. That is, all of the buffering and management functions do not reside in the Datalink layer, as is the case for the existing serial bus architecture.

More particularly, user applications for portable terminals have evolved so as to require certain guaranties on the QoS provided to data traffic (e.g., data packet traffic). In order to provide such QoS guaranties, the serial bus architecture is extended to include a subsystem that differentiates traffic into priority groups. The existing QoS subsystem implements most of the QoS management functionality on the Datalink layer by performing bandwidth allocation, an approach that may increase the complexity of both the underlying logic and implementation.

For example, and as described in U.S. patent application Ser. No. 10/961,366, the communications bus protocol permits for the allocation of bandwidth, where data sent or received by the Datalink layer is divided into frames, where a frame represents a total amount of bandwidth available at a given time, and where each frame is divided into channels, and a number of bytes allocated to a channel represents a percentage of the frame that can be used by a given channel. The bandwidth allocation procedures are preferably based on counting the number of bytes sent in a channel within a given frame, and if the number of bytes equals or exceeds the number of bytes allowed by the frame percentage of the channel, no further data is sent on this particular channel during the current frame. The channels may be divided into cells of a fixed size, and in a frame all cells can be intermixed regardless of the channel from which they originated.

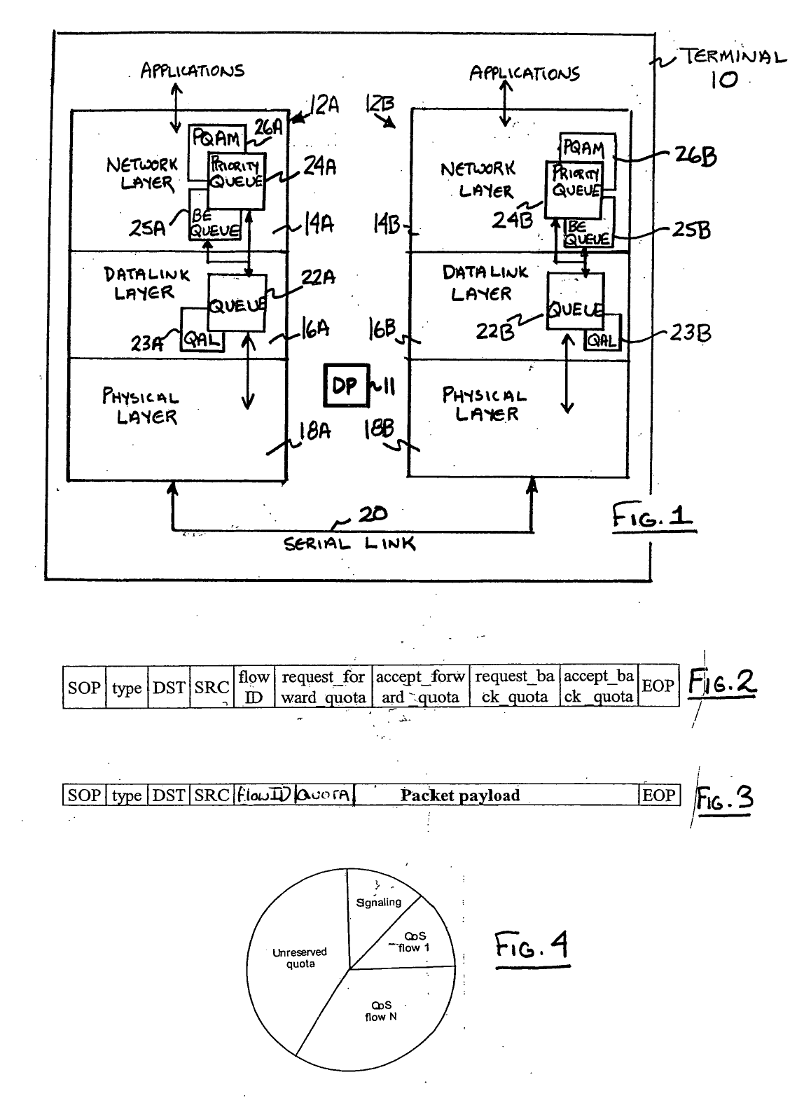

FIG. 1 is a block diagram of a terminal 10 that includes two exemplary functional units 12A, 12B that are constructed and operated in accordance with the non-limiting embodiments of this invention. In a non-limiting embodiment of the invention the terminal 10 may be a wireless communications terminal, and the functional unit 12A may comprise an application engine, control processor unit while the functional unit 12B may comprise a baseband unit. In other embodiments the terminal 10 may be a PDA, or a computer, or a digital camera, or a music player or, in general, any type of electronic device that uses a bus to communicate data between two or more constituent functional units. While only two functional units are shown in the terminal 10, there maybe several, including as non-limiting examples a radio frequency (RF) unit, a memory subsystem unit, a touch screen display unit, a camera unit, and one or more accessory or peripheral units (e.g., an accessory unit that plays music based on received digital data). The functional units 12A, 12B, collectively referred to as functional units 12, are connected via a serial link 20, such as one described in the above-referenced U.S. patent application Ser. Nos. 10/684,169, 10/961,366 and 10/961,661. The serial link 20 may use multi-valued logic to encode data. It should be noted that the serial link 20 may not make a direct connection between the two functional units 12, but may instead pass through a router unit and/or a concentrator/distribution/switching or hub unit (not shown). Each functional unit 12A, 12B includes a protocol stack comprised at least of a Network layer 14A, 14B (collectively referred to as Network layers 14), a Datalink layer 16A, 16B (collectively referred to as Datalink layers 16), and a Physical layer 18A, 18B (collectively referred to as Physical layers 18), respectively. The Network layers 14 will each typically interface to higher levels, which may include one or more of Transport, Session, Presentation and Application layers.

The Open System Integration (OSI) definition of layers may be used for convenience. In this non-limiting case the Physical layer 18 transforms logic signals into electrical or other signals on the transmission medium of the serial link 20, and also transforms received signals into a logic signal. The Datalink layer 16 is used to enable peer-to-peer communications, and the Network layer 14 provides the ability to send information from one node of a network to another.

In accordance with the non-limiting embodiments of this invention all or substantially all of the QoS traffic management functionality is implemented in the Network layers 14, thereby resulting in a significant complexity reduction of the implementation of the Datalink layers 16. For example, there is no need to provide special coding in the Datalink layers 16.

In the existing serial bus architecture each Datalink layer 16 has one input buffer and one output buffer for queuing both QoS and Best Effort (BE) traffic. These buffers are used as a direct source/destination for traffic going to/from the underlying Physical layer 18.

It is important to note that the Network layer 14 clearly separates treatment procedures for the QoS and BE traffic when the Datalink layer 16 receives all traffic as a unified flow. However, the non-limiting embodiments of this invention guaranty that the Datalink buffer(s) cannot be blocked by the low priority BE traffic, which is achieved by a standard-compatible modification of the flow control procedure.

In the presently preferred embodiments of this invention implementation complexity is reduced by re-locating all, or a majority of, the QoS-related functions to the Network layer 14. For this purpose the prior single QoS/BE buffer of the Datalink layer 16 is partitioned so as to provide a common buffer or Queue 22A, 22B (collectively referred to as Queue 22) residing in the Datalink layer 16, while the higher priority traffic is handled in the Network layer 12 in a Priority buffer or Queue 24A, 24B, collectively referred to as a Priority Queue 24. The Network layer 12 also includes a logically separate BE Queue 25A, 25B, collectively referred to as the Network layer BE Queue 25. Associated with the Priority Queues 24A, 24B is a Priority Queue 24 Access Mechanism (PQAM) 26A, 26B, respectively, collectively referred to as PQAM 26, and associated with the Datalink layer common Queues 22A, 22B is Queue Access Logic (QAL) 23A, 23B, respectively, collectively referred to as QAL 23.

The Priority Queue 24 functions as a temporary storage for the QoS traffic before it is transferred to a next hop. The PQAM 26 operates to schedule QoS flows (logical channels) in accordance with reservation requests. In the non-limiting embodiments of this invention the PQAM 26 supports two types of QoS reservations: per-flow reservations and per-packet reservations.

The per-flow reservation is a hard-type reservation that is performed when an application requires a continuous quality guaranty for a certain time interval. The per-flow reservation is performed by the PQAM 26 before an actual data flow is created. First, a flow originator (e.g., the functional unit 12A) sends a QoS reservation request packet to the flow destination (e.g., the functional unit 12B), which on the way to the flow destination verifies whether the requested resource can be allocated and sets at least one inactive reservation, and on the back way to the flow originator performs the actual resource allocation by activating the corresponding previously set at least one inactive reservation. A non-limiting example of a QoS Request/Acknowledgment packet is shown in FIG. 2, and includes the following fields:
SOP
type
DST
SRC
flowID
request_forward_quota
accept_forward_quota
request_back_quota
accept_back_quota
EOP

The SOP and EOP are Start of Packet and End of Packet markers. The type field specifies a packet type, in this case the QoS Request/Acknowledgment packet. The DST and SRC fields contain addresses of the destination and source, respectively, in this example the addresses of the functional unit 12B and the functional unit 12A, respectively. The flowID field is a unique network-wide identification of the flow provided by the application (e.g., based on application ID). The request_forward_quota and accept_forward_quota fields identify a requested resource quota and a minimum acceptable quota on the path from the source to the destination. The request_back_quota and accept_back _quota fields identify requested and minimum acceptable quotas on the path back from the destination to the source. In a non-limiting embodiment the units of the quota fields are defined in bytes per second.

The involved nodes (source, destination and intermediate switches) register resource reservation (e.g., the corresponding time slots) via a link access scheduling mechanism. An example of time division multiple access (TDMA) resource allocation scheduling is shown in FIG. 4. Note in FIG. 4 that signaling consumes some fraction of the available time, while the QoS flow 1 and QoS flow N together consume some additional fraction, leaving in this example some amount of unreserved quota (corresponding to bus time slots or bus bandwidth) for possible allocation to one or more additional QoS flows.

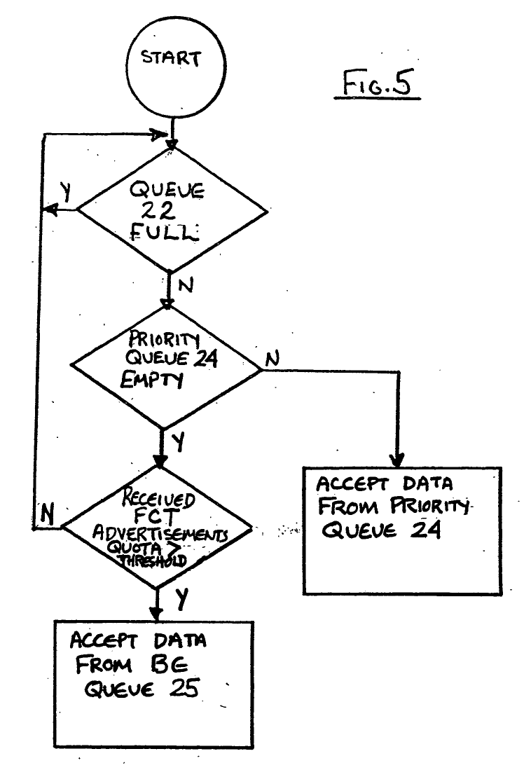

The reserved resource quota can be used all together at once, or it may be divided into multiple parts, depending on the inter-arrival time and packet size of the flows. A QoS Flow packet has the format shown in FIG. 3, and includes the following fields:
SOP
type
DST
SRC
flowID
quota
Packet payload
EOP

The SOP, type, DST, SRC and EOP fields have the same functionality as that defined for the QoS Request/Acknowledgment packet is shown in FIG. 2. The quota field defines a requested resource quota, and is followed by the actual QoS packet payload. The quota here represents a consumed quota, and in many cases may be the size of the payload, such that intermediate nodes may track what share of the quota was already used, and how much is still available for the given channel. The quotas are thus built on top of the bus bandwidth budgeting mechanism, and the reservation mechanism includes the quotas. The Network layer 14 preferably associates a given QoS flow packet with a reservation request made by a previous QoS Request/Acknowledgment packet through the use of the flowID field.

The QoS provided to the flow is guaranteed to be not less than what was acknowledged for the request. When the flow demands more than was reserved, the additional value is provided only if there are currently unreserved resources (shown in FIG. 4). The reservation is active while a new QoS request for NULL quota is not initiated.

Further in this regard, a NULL request may have the same packet format as shown in FIG. 2, where all four quota fields are set to zero (null). When an intermediate (switch) node receives such a request it deactivates the channel (on the forward path of the packet) and deletes the channel when the corresponding acknowledgment from the destination is received (on the backwards path).

It can be noted that a flow may demand more resources than it was granted and, if the source node permits such a flow to enter to the network (there is preferably a special policy for handling such cases at source nodes), the traffic in excess of the granted quota is handled on a Best Effort basis, meaning that the excess is not guaranteed a particular QoS, and may be rejected if there is insufficient link bandwidth.

Having this described the per-flow reservation, a description is now made of the per-packet reservation. The per-packet reservation is a soft-type of reservation that is used when a guaranty is needed only for a given data packet. In the per-packet mode the Network layer 14 does not guaranty delivery of the packet, however the packet receives a relative priority as per the other traffic, and delivered packets are guarantied to fulfill QoS requirements (for example, an end-to-end latency requirement). The packet is accepted for transmission over the link 20 if there are sufficient unreserved resources, otherwise it is discarded. The QoS packet format is the same as for the per-flow reservation (see FIG. 3), but does not require that actual resource reservation be accomplished.

Both QoS reservation modes (per-flow and per-packet) are accommodated using the same PQAM 26 functionality.

For the case of BE traffic the additional logically separated queue is used (the Network layer BE Queue 25). The Datalink Queue 22 access logic (QAL 23) may operate as follows: if the outbound (towards Physical layer 16) Datalink Queue 22 has free space, first take data from the Network layer QoS Queue 24, and only if the Network layer QoS Queue 24 is empty, take data from the Network layer BE Queue 25.

It can be noted that the use of the common Datalink layer Queue 22, and the logically independent treatment of the QoS and BE traffic at the Network layer 12 via the Network layer Priority Queue 24 and the BE Queue 25, could potentially lead to a logical link blocking condition. The link 20 could become logically blocked when the Network layer BE Queue 24 is full, and the inbound (from the Physical layer 16) Datalink layer Queue 22 contains a BE packet. The link could potentially remain blocked for some time, as the presence of QoS traffic (e.g., coming from another link) could result in the BE traffic not being served. Such a scenario is undesirable as it can degrade the requested QoS guaranties.

In order to prevent an occurrence of link blocking the flow control procedure uses Flow Control Tokens (FCTs) for permitting the transfer of a certain amount of data from the Datalink outbound Queue 22 on one end of the link 20 to the Datalink inbound Queue 22 at the other end of the link 20. One standard procedure advertises the total length of the inbound Datalink buffer. In accordance with an aspect of the teachings of this invention a modified procedure introduces a threshold value that specifies a number of FCTs advertised to the sender. If sender receives more advertisements than the threshold value, both QoS and BE packets are allowed to enter the link 20. Otherwise, only the QoS traffic is allowed to be placed into the outbound Datalink layer Queue 22. The receiver sends more than the threshold number of advertisements only if the corresponding incoming Network layer BE Queue 25 has free space. For example, assume that the total length of the incoming Network layer BE Queue 25 is 10 words, and assume further that the receiver sets the threshold value to be seven words. In this example the receiver can send up to seven FCTs, when the BE Queue 25 is full, and more than seven if there is a place for the corresponding one to three packets in the corresponding BE Queue 25. In a preferred, although non-limiting embodiment the FCTs are sent by the QAL 23 in FIG. 1 and thus originate in the Datalink layer 16.

Taking into account the foregoing modification of the flow control procedure, and referring to FIG. 5, the Datalink layer Queue 22 access logic 23 operates as follows: if the outbound Datalink Queue 22 has free space, first accept data from the Network layer QoS Priority Queue 24, and only if the Network layer QoS Priority Queue 24 is empty, and the number of received FCT advertisements exceeds the defined threshold, accept data from the Network layer BE Queue 25.

The techniques described above in accordance with non-limiting embodiments of the invention can be used with a number of different bus architectures. As one non-limiting example, the teachings of this invention maybe used in Spacewire-based systems (SpW, see http://www.estec.esa.n1/tech/spacewire/).

It should further be appreciated that some elements of the serial link management logic may be moved from the Network layer 12 to the Datalink layer 14, if it provides a more efficient implementation.

It should be further appreciated that the functionality of the PQAM 26 and the QAL 23 may be implemented in hardware, or in software, or as a combination of hardware and software. Thus, non-limiting embodiments of this invention may be implemented by computer software executable by one or more data processors (DP) 11 of the terminal 10, or by dedicated hardware, or by a combination of software and hardware. Further in this regard it should be noted that the various blocks of the logic flow diagram of FIG. 5 may represent program steps, or interconnected logic circuits, blocks and functions, or a combination of program steps and logic circuits, blocks and functions.

The foregoing description has provided by way of exemplary and non-limiting embodiments a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent serial or other types of bus architectures may be attempted by those skilled in the art, and the packet formats shown in FIGS. 2 and 3 may be re-arranged, and/or other fields may be added and/or some fields deleted. However, all such and similar modifications of the teachings of this invention will still fall within the scope of this invention.

Furthermore, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A functional unit comprising a protocol stack comprised of a physical layer for coupling to a communication link, a datalink layer coupled to the physical layer, and a network layer coupled to the datalink layer, said datalink layer comprising a common data queue for storing all traffic passing through said communication link and said network layer comprising a first queue for storing data associated with first traffic having a requested quality of service QoS and a logically separate second queue for storing data associated with second traffic not having a requested quality of service.

2. A functional unit as in claim 1, further comprising an access manager coupled to at least said first queue and responsive to receipt of a QoS Request/Acknowledgment packet to allocate at least one resource for first traffic to be received from a sender of the QoS Request/Acknowledgment packet.

3. A functional unit as in claim 2, where the QoS Request/Acknowledgment packet comprises fields SOP, type, DST, SRC, flowID, request_forward_quota, accept_forward _quota, request_back_quota, accept_back_quota, EOP, where SOP and EOP are Start of Packet and End of Packet, type specifies that the packet is the QoS Request/Acknowledgment packet, DST and SRC contain addresses of a destination and a source, flowID is an identification of a data flow that comprises the first traffic, request_forward_quota and accept_forward _quota identify a requested resource quota and a minimum acceptable quota on a path from the source to the destination, and request_back_quota and accept_back_quota identify requested and minimum acceptable quotas on a path back from the destination to the source.

4. A functional unit as in claim 1, operable with a flow control procedure that uses Flow Control Tokens FCTs for permitting the transfer of a certain amount of data from an outbound common queue in a first functional unit to an inbound common queue in a second functional unit.

5. A functional unit as in claim 4, further comprising an access logic coupled to at least said common queue, said access logic when embodied in the second functional unit advertising a total length of the inbound common queue in conjunction with a threshold value that specifies a number of FCTs advertised to the first functional unit sender, where if the first functional unit receives more advertisements than the threshold value, both the first traffic and second traffic are allowed to enter the communication link else only first traffic is allowed to enter the communication link, where the access logic of the second functional unit sends more than the threshold number of advertisements only if a corresponding incoming network layer first queue in not full.

6. A functional unit as in claim 5, said access logic being responsive to an outbound portion of the common queue having free space to accept data from the network layer first queue unless the network layer first queue is empty, and only if the network layer first queue is empty, and a number of received advertisements exceeds the defined threshold, to accept data from the network layer second queue.

7. A functional unit as in claim 1, further comprising an access manager coupled to at least said first queue and responsive to per-flow QoS reservations and to per-packet QoS reservations.

8. A functional unit as in claim 7, where a per-flow QoS reservation is made by an originator of a flow prior to the start of the flow that on a path to the flow destination verifies whether a requested resource can be allocated and sets at least one inactive reservation, and on the path back way to the flow originator performs resource allocation by activating the corresponding previously set at least one inactive reservation.

9. A functional unit as in claim 1, where the communication link comprises a serial communication link.

10. A method to communicate data over a communication link, comprising:
in a functional unit, providing a protocol stack comprised of a physical layer for coupling to the communication link, a datalink layer coupled to the physical layer, and a network layer coupled to the datalink layer;
in the datalink layer, operating a common data queue for storing all traffic passing through the communication link; and
in the network layer, operating a first queue for storing data associated with first traffic having a requested quality of service QoS and operating a logically separate second queue for storing data associated with second traffic comprised of best effort traffic.

11. A method as in claim 10, further comprising providing an access manager coupled to at least the first queue and, responsive to receipt of a QoS Request/Acknowledgment packet, allocating at least one resource for first traffic to be received from a sender of the QoS Request/Acknowledgment packet.

12. A method as in claim 1 1, where the QoS Request/Acknowledgment packet comprises fields SOP, type, DST, SRC, flowID, request_forward_quota, accept_forward_quota, request_back_quota, accept_back_quota, EOP, where SOP and EOP are Start of Packet and End of Packet, type specifies that the packet is the QoS Request/Acknowledgment packet, DST and SRC contain addresses of a destination and a source, flowID is an identification of a data flow that comprises the first traffic, request_forward_quota and accept_forward _quota identify a requested resource quota and a minimum acceptable quota on a path from the source to the destination, and request_back_quota and accept_back _quota identify requested and minimum acceptable quotas on a path back from the destination to the source.

13. A method as in claim 10, further comprising operating a flow control procedure that uses Flow Control Tokens FCTs to permit the transfer of a certain amount of data from an outbound common queue in a first functional unit to an inbound common queue in a second functional unit.

14. A method as in claim 13, further comprising providing an access logic coupled to at least the common queue, the access logic when embodied in the second functional unit performing advertising a total length of the inbound common queue in conjunction with a threshold value that specifies a number of FCTs advertised to the first functional unit sender, where if the first functional unit receives more advertisements than the threshold value, both the first traffic and second traffic are allowed to enter the communication link else only first traffic is allowed to enter the communication link, where the access logic of the second functional unit sends more than the threshold number of advertisements only if a corresponding incoming network layer first queue in not full.

15. A method as in claim 14, where the access logic is responsive to an outbound portion of the common queue having free space to accept data from the network layer first queue unless the network layer first queue is empty, and only if the network layer first queue is empty, and a number of received advertisements exceeds the defined threshold, to accept data from the network layer second queue.

16. A method as in claim 10, further comprising providing an access manager coupled to at least the first queue that responds to per-flow QoS reservations and to per-packet QoS reservations.

17. A method as in claim 16, making a per-flow QoS reservation by an originator of a flow prior to the start of the flow that on a path to the flow destination verifies whether a requested resource can be allocated and sets at least one inactive reservation, and on the path back way to the flow originator performs resource allocation by activating the corresponding previously set at least one inactive reservation.

18. A method as in claim 10, where the communication link comprises a serial communication link.

19. A computer program product embodied on a computer readable medium for directing at least one data processor to communicate data over a communication link by operations that comprise providing a protocol stack comprised of a physical layer for coupling to the communication link, a datalink layer coupled to the physical layer, and a network layer coupled to the datalink layer; in the datalink layer, operating a common data queue for storing all traffic passing through the communication link; and in the network layer, operating a first queue for storing data associated with first traffic having a requested quality of service QoS and operating a logically separate second queue for storing data associated with second traffic comprised of best effort traffic.

20. A computer program product as in claim 19, further comprising providing an access manager coupled to at least the first queue and, responsive to receipt of a QoS Request/Acknowledgment packet, allocating at least one resource for first traffic to be received from a sender of the QoS Request/Acknowledgment packet.

21. A computer program product as in claim 20, where the QoS Request/Acknowledgment packet comprises fields SOP, type, DST, SRC, flowID, request_forward_quota, accept_forward _quota, request_back_quota, accept_back _quota, EOP, where SOP and EOP are Start of Packet and End of Packet, type specifies that the packet is the QoS Request/Acknowledgment packet, DST and SRC contain addresses of a destination and a source, flowID is an identification of a data flow that comprises the first traffic, request_forward_quota and accept_forward _quota identify a requested resource quota and a minimum acceptable quota on a path from the source to the destination, and request_back_quota and accept_back _quota identify requested and minimum acceptable quotas on a path back from the destination to the source.

22. A computer program product as in claim 19, further comprising operating a flow control procedure that uses Flow Control Tokens FCTs to permit the transfer of a certain amount of data from an outbound common queue in a first functional unit to an inbound common queue in a second functional unit.

23. A computer program product as in claim 22, further comprising providing an access logic coupled to at least the common queue, the access logic when embodied in the second functional unit performing advertising a total length of the inbound common queue in conjunction with a threshold value that specifies a number of FCTs advertised to the first functional unit sender, where if the first functional unit receives more advertisements than the threshold value, both the first traffic and second traffic are allowed to enter the communication link else only first traffic is allowed to enter the communication link, where the access logic of the second functional unit sends more than the threshold number of advertisements only if a corresponding incoming network layer first queue in not full.

24. A computer program product as in claim 23, where the access logic is responsive to an outbound portion of the common queue having free space to accept data from the network layer first queue unless the network layer first queue is empty, and only if the network layer first queue is empty, and a number of received advertisements exceeds the defined threshold, to accept data from the network layer second queue.

25. A computer program product as in claim 19, further comprising providing an access manager coupled to at least the first queue that responds to per-flow QoS reservations and to per-packet QoS reservations.

26. A computer program product as in claim 25, making a per-flow QoS reservation by an originator of a flow prior to the start of the flow that on a path to the flow destination verifies whether a requested resource can be allocated and sets at least one inactive reservation, and on the path back way to the flow originator performs resource allocation by activating the corresponding previously set at least one inactive reservation.

27. A computer program product as in claim 19, where the communication link comprises a serial communication link.

28. A terminal comprising at least a first functional unit and a second functional unit that are communicatively coupled together through a link, each of the functional units comprising a protocol stack comprised of a physical layer for coupling to the link, a datalink layer coupled to the physical layer, and a network layer coupled to the datalink layer, said datalink layer comprising a common data queue for storing traffic passing through said link and said network layer comprising a first queue for storing data associated with first traffic having a requested quality of service QoS and a logically separate second queue for storing data associated with second traffic not having a requested quality of service.

29. A terminal as in claim 28, each of the functional units further comprising an access manager coupled to at least said first queue and responsive to receipt of a QoS Request/Acknowledgment packet to allocate at least one resource for first traffic to be received from a sender of the QoS Request/Acknowledgment packet.

30. A terminal as in claim 29, where the QoS Request/Acknowledgment packet comprises fields SOP, type, DST, SRC, flowID, request_forward_quota, accept_forward_quota, request_back_quota, accept_back _quota, EOP, where SOP and EOP are Start of Packet and End of Packet, type specifies that the packet is the QoS Request/Acknowledgment packet, DST and SRC contain addresses of a destination and a source, flowID is an identification of a data flow that comprises the first traffic, request_forward_quota and accept_forward _quota identify a requested resource quota and a minimum acceptable quota on a path from the source to the destination, and request_back_quota and accept_back quota identify requested and minimum acceptable quotas on a path back from the destination to the source.

31. A terminal as in claim 28, operable with a flow control procedure that uses Flow Control Tokens FCTs for permitting the transfer of a certain amount of data from an outbound common queue in the first functional unit to an inbound common queue in the second functional unit.

32. A terminal as in claim 31, further comprising an access logic coupled to at least said common queue, said access logic when embodied in the second functional unit advertising a total length of the inbound common queue in conjunction with a threshold value that specifies a number of FCTs advertised to the first functional unit sender, where if the first functional unit receives more advertisements than the threshold value, both the first traffic and second traffic are allowed to enter the link else only first traffic is allowed to enter the link, where the access logic of the second functional unit sends more than the threshold number of advertisements only if a corresponding incoming network layer first queue in not full.

33. A terminal as in claim 32, said access logic being responsive to an outbound portion of the common queue having free space to accept data from the network layer first queue unless the network layer first queue is empty, and only if the network layer first queue is empty, and a number of received advertisements exceeds the defined threshold, to accept data from the network layer second queue.

34. A terminal as in claim 28, each of the functional units further comprising an access manager coupled to at least said first queue and responsive to per-flow QoS reservations and to per-packet QoS reservations.

35. A terminal as in claim 34, where a per-flow QoS reservation is made by an originator of a flow prior to the start of the flow that on a path to the flow destination verifies whether a requested resource can be allocated and sets at least one inactive reservation, and on the path back way to the flow originator performs resource allocation by activating the corresponding previously set at least one inactive reservation.

36. A terminal as in claim 28, where the link comprises a serial link.

37. A terminal as in claim 28, comprising a wireless communications device.
